(19) United States
(12) Patent Application Publication
(10) Pub. No.: US 2013/0171228 A1
(43) Pub. Date: Jul. 4, 2013

(54) ANTI-MICROBIAL METAL ORGANIC FRAMEWORK

(71) Applicant: Russell Edward Morris, St. Andrews (GB)

(72) Inventor: Russell Edward Morris, St. Andrews (GB)

(73) Assignee: University Court of the University of St. Andrews, St. Andrews (GB)

(21) Appl. No.: 13/816,220

(22) PCT Filed: Aug. 8, 2011
(86) PCT No.: PCT/GB11/01184

§ 371 Date: Mar. 11, 2013

(30) Foreign Application Priority Data
Aug. 9, 2010 (GB) 1013307.2

(51) Int. Cl. A01N 55/02; C07F 15/04; C07F 1/08; A01N 59/02; C07F 3/06; A01N 59/00; A01N 43/50

(52) U.S. Cl. CPC A01N 55/02; A01N 59/00; C07F 15/045; A01N 43/50; A01N 59/02; C07F 3/06; C07F 1/08
USPC 424/409; 424/718; 556/138; 424/708; 556/118; 556/110

(57) ABSTRACT

The present invention relates to metal organic framework materials which possess anti-microbial properties. The present invention also provides methods of preparing such metal organic framework materials and uses of the metal organic framework materials to prevent or treat microbial infections, or provide surfaces which limit contamination by micro-organisms.

### FIELD OF INVENTION

The present invention relates to metal organic framework materials which possess anti-microbial properties. The present invention also provides methods of preparing such metal organic framework materials and uses of the metal organic framework materials to prevent or treat microbial infections, or provide surfaces which limit contamination by micro-organisms.

### BACKGROUND OF INVENTION

A significant portion of the antibacterial market is taken up by inorganic, metal-based materials whose mechanism of action is based on the slow delivery of metal ions (usually Ag⁺, Zn²⁺, Cu²⁺) into the environment. This technology has a large market share in Japan, and increasing share across North America and Europe, with projected growth in the latter of 20-25% pa over the next few years (made even more likely after the effects of the EU REACH and Biocidal Products Directives). Particularly prevalent are the Ag- and Zn-zeolites sold by companies such as Agion in packaging, medical, clothing and many other applications (see www.agion-tech.com). This company has been hugely successful in forging partnerships with companies in many different sectors to provide anti-bacterial solutions. For example, Agion sells to manufacturers of consumer (incl electronics, apparel, sportsware, office and personal care products), healthcare (incl medical devices, hospital fixtures and hardware, specialized cleaning, tubings and films etc) and industrial products (incl food, water, textile, HVAC and construction products). Clearly the breadth of the market is large and the drivers to incorporate anti-bacterial agents in all these (and many other) products are strengthening, with significant potential for growth.

The state-of-the-art in porous materials has led to some of the most important new materials discovered in recent years, particularly in the area of metal organic frameworks (MOFs). Ultra high surface area solids,¹ dynamic and responsive materials (e.g. the breathing frameworks of Ferey's group² and other work³) and many of the other recent advances have had impact on some of the most important questions of our time—energy storage, carbon capture, new materials for medicine and novel catalysts for improved chemical processes. Despite this great success there are still huge challenges in the field. Commercial applications of these materials are just now being developed in several of these areas, but primarily in gas storage and chemical separations.

In these solids metal ions or clusters of metal ions (Mn+, n=1,2,3,4) are linked together with organic units (Ly−, y=0, 1, 2, 3, 4 . . . ) to form two dimensional or three dimensional networks. Many of these networks show good thermal stability and some are extremely porous, with up to ˜90% free volume.⁴ However, metal organic frameworks can also be non-porous materials.⁵ Only certain metal organic frameworks can be prepared as porous solids, and porosity is only introduced into the materials after a thermal or chemical activation process that removes any guest or solvent molecules that remain in the channels/pores of the structure. The chemical activation process may also produce coordinatively unsaturated metal ions that have sites where guest molecules or species can be bound into the structure more strongly than is possible without such sites.

One of the most exciting potential applications of porous materials is in the area of bio-functional solids. To that end Ferey⁶ (France), Lin⁷ (USA) and the present inventors⁸ have been developing these materials for use as cancer drug delivery, MRI contrast agents and medical gas delivery solids respectively. During this work the various groups have shown that, depending on the composition, these materials have excellent toxicology and suitable chemical stability properties in contact with physiological solutions, which make them particularly attractive for biological and medical applications.

It is an object of the present invention to provide new MOF materials and uses of MOFs.

It is an object of the present invention to provide new MOFs with useful application.

### SUMMARY OF THE INVENTION

In a first aspect the present invention provides a method of preventing or treating microbial infection or contamination, the method comprising contacting a material comprising a metal organic framework (MOF) material which has been modified by way of incorporating two or more anti-microbial agents, with a microbe, so as to prevent or treat a microbial infection or contamination.

The MOF technology described herein has significant advantages over the currently used zeolite based technology. The first is the cost of manufacture. MOFs can be manufactured on a large scale (companies like BASF are already doing this—see http://www.basf-futurebusiness.com/en/projects/gas-storage.html). Unlike zeolites, which require a two step manufacturing process—synthesis followed by ion exchange to introduce the silver/zinc—MOFs only require a one step synthesis to incorporate the active metal making the process much more cost effective. In addition, in MOFs the metal is in the matrix itself and each metal site in the MOF is available. The active metal per mass of the material can therefore be much higher than in zeolites where most of the mass is inactive aluminosilicate matrix.

Taken together these advantages already make a strong case for the development of MOF-based antibacterial materials, particular for relatively low value applications (consumer goods etc) where the cost of the material is extremely important. However, MOFs also have important advantages which could make them extremely attractive for incorporation into high value products (e.g. medical applications). The extremely high porosity of MOFs makes them extremely good nanocarriers for gases (see WO 2008/020218) and drug molecules. This allows the manufacture of much more effective anti-bacterial agents than Ag/Zn zeolites alone.

Similarly, anti-bacterial drugs can be loaded in extremely high amounts into MOFs, which control their delivery into the environment extremely well. The multi-functional nature of the action (with two or more different mechanisms of action) can reduce the problems associated with microbial resistance. Combining the projected cost of the materials with their distinct advantage in terms of multifunctionality will allow targeting of different areas of the anti-microbial market.

The anti-microbial activity of MOFs may come from one or more features of the material

Typically, the metal organic framework itself contains one or more types of anti microbial agent. To show this type of behaviour the framework can either be porous or non-porous, and may be used in both activated or unactivated (as made) states.

For example,

(a) the metal in the framework can be active against microbes (many different metal ions, but preferably silver (Ag⁺) or zinc (Zn²⁺) or copper (Cu⁺ or Cu²⁺) or nickel (Ni²⁺) may be employed. The metal organic framework may contain only one type of metal ion, or may contain two or more types of metal ion in the same phase;

(b) the organic linker used in the framework can have antimicrobial activity. The metal organic framework may have only one liker that is antimicrobial, or it may contain more than one type of linker, one or more of which may have anti microbial activity; and

(c) the framework may be multifunctional by virtue of having both anti-microbial metal ions and anti-microbial linkers present.

(d) in a further aspect there is provided a metal organic framework comprising two or more guest molecules incorporated with the metal organic framework. Typically said molecules are incorporated within the pores of the metal organic framework.

It is perhaps surprising that the inventors have been able to incorporate more than one type of molecule within the pores of a metal organic framework, as it may have been expected that incorporation of one molecule would fill any available space, hence limiting incorporation of a second molecule, the present inventors have been able to incorporate further molecules and show that these can be stored within a metal organic framework prior to their release. Typically such molecules will be all medium sized organic or metal-organic molecules that are usually solid or liquid under ambient conditions (the maximum size of which will be determined by the size of the metal organic framework pores), or a mixture of one medium sized solid/liquid molecule and at least one type of small molecule that is gaseous under ambient conditions, or a mixture of different gaseous molecules. In a preferred embodiment the molecules comprise a mixture of solid/liquid molecules and gaseous molecules. It is to be appreciated that the molecules concerned are additional molecules to the metal organic framework and would conventionally not be considered to be part of the framework. The molecules are not therefore to be interpreted to include the metal ions which may be part of the metal organic framework. However, metal ions could also be incorporated as guests into the pores of the metal organic frameworks.

Many guest molecules can be envisaged, but typical molecules include molecules designed to be biologically or physiologically active. Such molecules may have, for example, a therapeutic or other biological activity. In one embodiment, one guest molecule may be anti-microbial, and the other guest molecule may serve to render the microbe more sensitive to the anti-microbial agent. Alternatively, the other molecule may simply be a repelling molecule designed to repel microbes, such as may be used in anti-fouling applications.

As examples we could envisage the delivery of a physiogically active drug molecule that has no antibacterial activity in itself (e.g. an anti-cancer drug such as doxorubicin or another drug such as caffeine) in combination with an anti-microbial gas such as nitric oxide, which will help to prevent infection or bacterial contamination.

The present invention will now generally be further described with regards to anti-microbial guest molecules, but this should not be construed as limiting and may be extended to the other guest molecules described herein.

The anti microbial agents can be incorporated and stored in the pores of the solid metal organic framework and then released into the environment either spontaneously or on the action of a trigger (such as exposure to moisture or a chemical agent, increase in temperature etc.). The antimicrobial agents that can be stored in metal organic frameworks range from small molecules (such as carbon monoxide, hydrogen sulphide, nitrogen monoxide etc) to organic antimicrobial agents (all classes of these antimicrobial agents can be incorporated in metal organic frameworks, including, but not limited to, the following classes—penicillins (e.g. amoxicillin, penicillin), cephalosporins (all generations), aminoglycosides (e.g. neomycin, streptomycin), glycopeptides (vancomycin etc), macrolides (erythromycin etc). As well as anti-bacterial agents, anti-viral and/or anti-fungal agents could be stored and adsorbed in a similar fashion. The anti-microbial agent in the pores could also be a non-framework metal ion or metal nanocluster (e.g. silver, copper, zinc, nickel etc).

For anti-biofilm activity it is also good to store molecules that cause bacterial biofilms to disassemble (particularly D-amino acids such as D-leucine, D-methionine, D-tyrosine, D-tryptophan etc, or mixtures of amino acids⁹) in combination with a potent antimicrobial MOF or antibmicrobial guest molecule such as nitric oxide.

A MOF with an antibacterial linker can be synthesised by taking the metal source—a metal salt (nitrates, chlorides sulfates etc of the desired metal) or metals themselves—and combining this with an organic linker with the correct anti-bacterial activity and suitable functionality. The preferred functionality is at least two carboxylic acid groups, two amine groups (or one carboxylic acid and one amine) so that they link the metal/metal clusters into a multidimensional framework. Examples of suitable organic linkers with antimicrobial properties include several of the penicillin family of antibiotics, such as carbenicillin, ticarcillin, etc and several others. The antibacterial MOF-containing materials can then be prepared by heating the components in a suitable solvent (water, ethanol, dimethylformamide are among many suitable solvents) to a suitable temperature before filtering or otherwise collecting the solid product.

Non-framework antibacterial metal ions can be incorporated into the pores of a MOF thourgh ion exchange or impregnation processes from the solution state, or as nanoclusters through impregnation of a metal complex in the solution or gaseous state followed by a reduction process to form the metals.

There is much scope to alter the property of the metal organic framework to suit the particular anti-microbial agent to be adsorbed. For example there are a wide range of possible pore sizes available in different metal organic frameworks (from small pore (<5 Å diameter), low BET surface area solids (<500 m² g⁻¹, e.g. SIAM-1) to large pore (>15 Å diameter) and ultra high surface area (>5000 m² g⁻¹, e.g. MIL101) which will change the diffusion properties of the antimicrobial agent. Similarly it is possible to prepare metal organic frameworks with different chemical functionality on the internal surface. This can allow adsorbed anti-microbial agents to be physisorbed or chemisorbed on the internal surface. For example, it is possible to prepare, after the metal organic framework has been activated, materials that have open metal sites (also called coordinatively unsaturated sites) where guest molecules can bind strongly and held relatively tightly inside the pores, affecting the rate at which they are released. Alternatively, the organic linkers can bear chemical functionality (e.g. —OH, —NO₂, —NH₂ etc) that can also be used to modify the strength of the interaction with the framework. For example, an anti-bacterial agent that has the possibility for hydrogen bonding can interact with an —OH or —NH₂ group on the framework to form a stronger interaction than would normally be the case.¹⁰

A major advantage of the metal organic framework approach is that the anti-microbial action can be multifunctional by virtue of utilising more than one type of anti-microbial agent. The following situations can be viewed as examples

a. A porous metal organic framework comprising an anti-microbial metal ion can be used to adsorb and store, and then release anti-microbial agents such as nitrogen monoxide, carbon monoxide or one of the anti-bacterial molecules described above. The porous material can also incorporate a combination of these agents. The advantages of this approach are that

(i) the anti-bacterial agents will be released from the MOFs at different rates. For example, a porous metal organic framework material may be formed from an antimicrobial metal (e.g. Ni, Cu, Ag or Zn) that is then used to adsorb a small anti-microbial agent (such as nitrogen oxide or carbon monoxide). The small agent may be released quickly into the environment, reducing the bacterial load in a short time. A larger anti-bacterial (such as an anti biotic drug molecule) might be released more slowly while the metal ions that form part of the metal organic framework are likely to released more slowly, keeping the bacterial load at low levels for a long period of time.

(ii) there will be multiple mechanisms of anti-microbial action from this approach, which will potentially reduce any problems associated with resistance to any one agent.

b. An activated or partially activated porous metal organic framework comprising a linker with anti-microbial activity can also adsorb and store an anti-microbial agent in its pores. The anti-microbial agent may be the same in both cases (i.e. the linker is the same chemical species as the adsorbed agent) or they may be different species. The advantages of this approach are the same as that described above (except in the case where the linker and the adsorbed antibacterial agents are the same, when the mechanism of action will obviously be the same).
c. The anti-microbial activity in the material can be a combination of (a) and (b) above. For example, the anti-microbial metal organic framework may comprise an anti-microbial metal and an anti-microbial linker, and then adsorb one (or even more) anti microbial agents.

As will be appreciated, a great many combinations of materials and anti-microbial agents may me envisaged.

The anti-microbial (or other guest molecule containing) metal organic frameworks described above may be incorporated into other products/materials. For example, the metal organic frameworks can be incorporated into

a. polymers and plastics—examples are incorporation of metal organic frameworks into PTFE, polyisobutyrate (e.g. hydrocolloids), polyurethanes, powder coatings etc etc imbuing the final material with anti-microbial activity
b. creams and lotions
c. textiles and clothing materials.
d. paints and coatings (including inks etc)

Prior to guest molecule adsorption (loading), the metal organic frameworks for use in the present invention may (or may not) be fully or partially activated. The term ‘activated’ refers to the metal organic framework being presented in a state in which guest molecule may be adsorbed at least ‘irreversibly’ to some degree. The frameworks may inherently allow the guest molecule to be adsorbed irreversibly—strongly bound (at least to some extent), in which case, activation may not be required, or activation may be used to increase the amount of guest molecule which may be adsorbed.

If required, activation generally involves the removal of guest molecules/species from the interior of the pores and/or channels of the framework to allow the anti-microbial molecule to be adsorbed into the metal organic framework. The guest molecules/species may be coordinated to the metals in the metal organic framework, and the activation of the framework materials may include removal of such coordinated molecules/species. The guest molecules/species may be nucleophiles.

For example, the metal organic framework may become coordinatively activated, wherein the activated metal organic framework includes a site available for coordination on some or all of the metal cations that form part of the framework itself. The available metal cations are thus available to strongly (‘irreversibly’) bind the guest molecule through coordination of the molecule to the metal cation(s).

The term ‘irreversible’ adsorption of a guest molecule refers to the guest molecule which is bound to the metal organic framework strongly and is not substantially desorbed from the material once the guest molecule-containing atmosphere used to load the material with the guest molecule is removed, in particular, at a reduced pressure. Without wishing to be bound by theory, this irreversible adsorption is understood to be a chemisorption process (i.e. there is a chemical bond formed between the guest molecule and the metal organic framework material) or a strong physisorption process. The presence of irreversibly adsorbed guest molecule may be indicated by a strong hysteresis between the adsorption and desorption arms of the adsorption/desorption isotherm.

In contrast, a reversibly adsorbed guest molecule is weakly bound to the material and desorbs once the guest molecule-containing atmosphere used to load the material with the guest molecule is removed. The guest molecule adsorbed by this mechanism is thereby termed ‘reversibly’ bound.

Activation may be achieved chemically, optionally followed by other non-chemical means or vice versa.

Chemical activation tends to remove the unwanted guest molecules from the framework by chemical displacement of the guest molecules by the molecules of the chosen activating chemical species.

The other, non-chemical, means for activation may include heating the metal organic framework at ambient (e.g. atmospheric) or reduced pressure. Subjecting the framework material to reduced pressure in absence of heat may also be used.

Methods include, for example, placing the framework under vacuum at elevated temperatures.

Other, non-chemical means for activation include exposing the metal organic framework to electromagnetic radiation, e.g. ultraviolet light.

Preferably, the framework is subjected to a chemical activation procedure followed by heating. Such method advantageously may take advantage of a step-wise activation procedure whereby guest molecules/species are preferentially displaced by a different chemical entity which itself becomes a guest molecule/species, which is then removed from the framework under reduced pressure and/or heating the framework material.

Chemical activation may be achieved using a chemical treatment method such as exposure of the framework material to a desired chemical or a mixture of chemicals.

Examples of suitable chemicals include solvents such as acetonitrile (CH₃CN), dimethylformamide (DMF), ethanol (EtOH) or methanol (MeOH).

Typical pressures, preferably reduced pressures, which may be used for activation include a pressure less than atmospheric pressure, e.g. less than 1 bar, such as from about 1×10⁻⁴ mbar to about 1 bar.

Typical temperatures, preferably elevated temperatures, which may be used for activation include a temperature up to about 450° C., for example, from about 20° C. to about 250° C., preferably, about 50° C. to about 150° C., most preferably about 80° C. to about 120° C., e.g. about 110° C.

The guest molecules may comprise water, in which case, activation of the framework includes full or partial dehydration of the framework material, to remove water. Other guest molecules such as residual solvent or gases may also be removed from the metal organic framework by the activation methods described herein,

The activation of the metal organic frameworks may also involve a change in structure of the framework to enable the anti-microbial molecule to be adsorbed irreversibly.

The resulting metal organic framework may then be exposed to the anti-microbial molecule to load the metal organic framework.

Typically, the anti-microbial molecule loading is performed at a temperature of from −100° C. to 50° C.

The loading of an anti-bacterial molecule that is normally solid or liquid under ambient conditions is done either in the vapour phase if the solid/liquid is volatile or from a solution in a suitable liquid solvent (the nature of the solvent will depend on the nature of the molecule).

The loading of an anti-bacterial gas is typically performed at a pressure at or above atmospheric pressure, for example from atmospheric pressure up to a pressure of about 10 bar. Atmospheric pressure is generally understood to mean a pressure of about 1 bar.

The loading of both a solid/liquid molecule and an anti-microbial gas is done in a stepwise fashion, first loading the solid/liquid molecule as described above, followed by a secondary activation process, most preferably carried out between about 80° C. to about 120° C., followed by loading of the anti-bacterial gas as described above.

The anti-microbial molecule loaded metal organic frameworks may be sealed inside airtight packaging for storage and transport purposes.

The airtight packaging may conveniently contain a dry atmosphere under which the metal organic framework is sealed.

Upon exposure of the anti-microbial (and/or other guest) molecule loaded metal organic framework to a suitable nucleophile, for example an aqueous environment such as water or blood, the anti-microbial (and/or other guest) molecule is displaced from the metal complex inside the metal organic framework resulting in release of anti-microbial (and/or other guest) molecule into the aqueous environment.

Thus, the irreversibly adsorbed anti-microbial (and/or other guest) molecule may be considered to be releasably adsorbed when conditions under which its release is triggered are applied.

The release of the irreversibly adsorbed/bound anti-microbial molecule (and/or other guest molecule) may be triggered by the action of another species, e.g. one which preferentially becomes the guest in the metal organic framework, for example, displaces and takes the place of the original anti-microbial molecule (and/or other guest molecule) at the coordination sphere of the metal cation in the metal organic framework. Such species include, for example, nucleophile species, and the method of release may comprise using a nucleophile-containing medium such as moist gas or an aqueous medium/solution, or by other means such as subjecting the anti-microbial (and/or other guest) containing material to an elevated temperature or exposure to electromagnetic radiation, e.g. ultraviolet light.

The anti-microbial molecule (and/or other guest molecule) loaded material may be subjected to one or more these methods to render the irreversibly bound anti-microbial molecule (and/or other guest molecule) releasable, prior to subjecting the material to conditions to actually release the irreversibly bound anti-microbial molecule.

The anti-microbial molecule (and/or other guest molecule) may be released from the loaded metal organic framework when placed in air, e.g. moist air.

The release of anti-microbial molecule may occur at a variety of temperatures, however room temperature (about 25° C.) or body temperature (about 38° C.) is preferred.

Metal organic framework materials, including those described herein, especially when activated as described herein, irreversibly adsorb a high capacity of anti-microbial molecule, making the materials particularly suitable for anti-microbial molecule adsorption, storage and/or release.

Typically, more than 1 mmol, e.g. up to about 5 mmol of anti-microbial molecule per gram of the metal organic framework may be adsorbed, and this corresponds to greater than three times the adsorption capacity of other known porous materials such as zeolites. The amount adsorbed may however be less, such as up to 3 mmol or 4 mmol, e.g. up to about 1.5 mmol or 2.0 mmol guest molecule per gram of the metal organic framework. Thus, a range of about 1 mmol to 7 mmol may be envisaged.

Ideally, the organic metal framework should have a high capacity for irreversibly adsorbed anti-microbial molecule, for example, substantially all of the initially loaded anti-microbial molecule is irreversibly adsorbed.

Preferably, the amount of irreversibly adsorbed anti-microbial molecule (and/or other guest) is about 1.0 mmol, or greater, per gram of metal organic framework material. For example, the amount of irreversibly adsorbed anti-microbial molecule is from about 1.0 mmol per gram to about 4.0 mmol per gram.

Typically, the mole ratio value of irreversible to reversible bound anti-microbial molecule is from about 2 to about 7, e.g. from about 2.5 to about 6, e.g. about 3.5. As mentioned above, higher ratios are preferred.

The precise amounts of anti-microbial molecule (and/or other guest molecule) measured in calculating the indicated ratios depends at least partially on the measurement conditions such as adsorption/desorption temperature and pressure. Generally, an isotherm graph may be generated for measurement purposes, showing adsorption and desorption arms, spanning a pressure of from about zero (e.g. about 1×10⁻² mbar) to about 1000 mbar (atmospheric pressure) at 298K (about room temperature), with the amounts of guest molecule for calculation purposes each being recorded at about zero pressure. Thus, as an example, at room temperature, at the start of the measurement at the starting zero pressure, the amount of anti-microbial molecule adsorbed in a chosen metal organic framework material is zero, rising to e.g. about 1.75 mmol guest molecule per gram at 1000 mbar, and reducing to about 1.25 mmol per gram on reducing the pressure to zero again. That is, 0.5 mmol per gram of anti-microbial molecule (and/or other guest) is reversibly adsorbed. The residual 1.25 mmol per gram of anti-microbial molecule (and/or other guest molecules) is the irreversibly adsorbed anti-microbial, and the ratio between the irreversible to reversible anti-microbial molecule (and/or other guest molecules) is 1.25/0.5=2.5.

The anti-microbial molecule (and/or other guest) loaded metal organic framework may be prepared in the form of a powder or a monolith for use for example in topical therapeutic applications or for ex vivo uses such as in vitro applications such as surface coatings of materials to make them resistant to microbial fouling/contamination.

Monoliths may be formed by compression of a metal organic framework powder or by mixing a powdered metal organic framework with a suitable binder which is well known in the manufacture of metal organic framework catalysts.

Suitable binders include, but are not limited to, ceramic binders, e.g. silica or alumina, and polymeric binders, e.g. polysulfone, polyethane, PET, polystyrene, polytetrafluorethylene (PTFE), polyurethane and other polymers.

Alternatively the metal organic frameworks may be provided as coatings on, for example, medical devices such as metallic medical devices. The coated devices may then be delivered to the locality where the anti-microbial action is required.

Typically, the metal organic frameworks are provided in a suitable form as discussed above, and then loaded with an anti-microbial agent ready for storage under dry conditions and used at a later time.

A powdered metal organic framework loaded with an anti-microbial agent may be used in topical applications such as for wound dressing, and may be provided in a bandage for application to a wound for release of the anti-microbial agents into the wound to aid healing. A metal organic framework provided as a monolith may be used e.g. for topical applications or, for example, for internal application in the prevention or treatment of microbial infection.

According to a further aspect of the present invention, there is provided a metal organic framework material comprising two or more anti-microbial molecules (and/or other guest molecules) for use in surgery and/or therapy.

According to a further aspect of the present invention, there is provided a pharmaceutical, neutraceutical or cosmetic preparation comprising a metal organic framework material comprising two or more anti-microbial molecules (and/or other guest molecules) together with a pharmaceutical/neutraceutical/cosmetic carrier therefor.

In a further aspect, the present invention provides the use of a metal organic framework material comprising two or more anti-microbial molecules (and/or other guest molecules) for the preparation of a medicament for use in the treatment or prophylaxis of disease.

Diseases or medical conditions which may be treated include infections of the skin, including dermatophyte fungi; leishmaniasis, molluscum and papilloma virus, and mycobacterium infections. Further uses include wound and/or burn healing. Therapies for other bacterial problems include the reduction of severe foot or body odour problems, and in the treatment of Methicillin Resistant Staphylococcus Aureus infections.

According to a sixth aspect of the present invention there is provided a medical article comprising a metal organic framework material comprising two or more anti-microbial molecules (and/or other guest molecules).

Suitable medical articles for use in the present invention include stents, catheters, wound dressings, bandages, self-adhesive plasters and patches.

The beneficial properties of the anti-microbial agents may be advantageously employed in cosmetic and personal hygiene applications.

For example the metal organic framework materials of the present invention which comprise releasably adsorbed anti-microbial agents may be used in cosmetic preparations; deodorants; skin preparations such as anti-aging skin preparations and preparations applied before, during or after hair removal by shaving or by application of depilatory preparations; hair preparations; depilatory preparations and the like.

The present invention also provides, as a further aspect, a method of releasing said two or more anti-microbial molecules (and/or other guest molecules) comprising the steps of
(i) providing a metal organic framework material comprising two or more anti-microbial agents;
(ii) contacting said metal organic framework material with a medium into which said two or more anti-microbial agents (and/or other guest molecules) is to be released.

Such release of the anti-microbial molecule (and/or other guest molecules) is preferably achieved in a controlled manner, for example, by providing a suitable metal organic framework material with an established controlled release profile.

The medium into which the anti-microbial molecule (and/or other guest molecules) is to be released may be simply air surrounding the metal organic framework material, or may be, for example, an aqueous medium.

The release may be performed either inside an animal body, topically to an animal body or ex vivo in non-body applications such as release from surfaces such as clinical and food preparation sites.

The release may be performed at any suitable temperature, however room or body temperature is preferred.

The method of releasing the anti-microbial molecule (and/or other guest molecules) may be applied to the treatment of humans or animals and accordingly the present invention further provides as a further aspect a method of treatment or prophylaxis of an individual in need thereof comprising providing a metal organic framework material comprising said two or more anti-microbial (and/or other guest molecules) and contacting said metal organic framework material with said individual.

Metal organic frameworks (MOFs) of the present invention are a class of nanoporous material. In these solids the metal ions (Mⁿ⁺) are linked together with linkers (L^{y-}) to form three dimensional networks.

In metal organic frameworks the metals may comprise any of a number of metal cations, such as transition metal cations, alkali metal cations, alkaline earth metal cations and other suitable metal cations, such as for example aluminium cations.

For example, suitable transition metal cations may include one or more of the following: Tiⁿ⁺, Vⁿ⁺, Crⁿ⁺, Mnⁿ⁺, Feⁿ⁺, Coⁿ⁺, Niⁿ⁺, Cuⁿ⁺, Znⁿ⁺, Agⁿ⁺, Ru, Rh where n is 1, 2, 3 or 4, depending on the metal and the oxidation state of that metal.

Suitable transition metal cations include Cu⁺, Cu²⁺, Mn²⁺, Mn³⁺, Zn²⁺, Fe²⁺, Fe³⁺, V³⁺, V⁴⁺, Ag⁺, Ru³⁺, Rh³⁺, Ni²⁺, Cr²⁺, Co²⁺ and Co³⁺.

Suitable alkali metal cations include Na⁺ and K⁺.

Suitable alkaline earth metal cations include Ca²⁺ and Mg²⁺.

Other metal cations include for example Al³⁺.

Transition metal cations are preferred, for example preferred metal cations may be selected from Cu⁺, Cu²⁺, Cr²⁺, Zn²⁺, Co²⁺, Co³⁺, Ag⁺, Mn²⁺ and Mn³⁺.

The metal organic framework may comprise any one or more than one of the above listed types of metal cations together in the same framework material and optionally one or more anti-microbial metal ions.

Mixtures of more than one type of organic framework material may also be provided.

For biological, medical and/or cosmetic applications (see herein below), preferred metal cations are those which are deemed toxicologically acceptable for such uses, e.g. those metals which are considered to have acceptable/limited toxicity, particularly when presented in the framework material, although such considerations will depend on the circumstances of the use and may be determined by the skilled practitioner as appropriate.

The ligand linkers (L) may comprise organic compounds (i.e based on carbon) containing multiple coordinating atoms or functional groups.

For example, each ligand may include 2-10 coordinating sites, e.g. 2-6 coordinating sites, most preferably 2-4 coordinating sites, for example 2 or 3 coordinating sites.

The coordinating sites may provide an electron donating moiety, e.g. a lone pair of electrons, a negative charge, or atoms or groups capable of forming such moieties.

Typically, each ligand is a dentate ligand, for example a bidentate, tridentate or other multiple-dentate ligand.

Preferred ligands include carboxylate ligands, for example, 1,4-benzenedicarboxylic acid, 1,3,5-benzene tricarboxylic acid or the like, each of which is presented as the carboxylate ion species in the framework.

Other preferred ligands include amines, for example, 1,4-bipyridine or the like.

The metal-organic frameworks may comprise or contain additional entities to those described above, for example, further metal or other positively charged ions, or other anionic species.

Further anions may include halogens, e.g. Cl⁻, F⁻, Br⁻ or I⁻ or other anions, e.g. OH⁻ or SO₄⁻.

The metal organic frameworks may in particular include species/molecules, within guest sites, such as pores or channels, formed in the framework. Such species may be for example water, solvent or other molecules e.g. derived from the components used in the manufacture of the framework.

The present invention will now be further described by way of example and with reference to the figures which show:

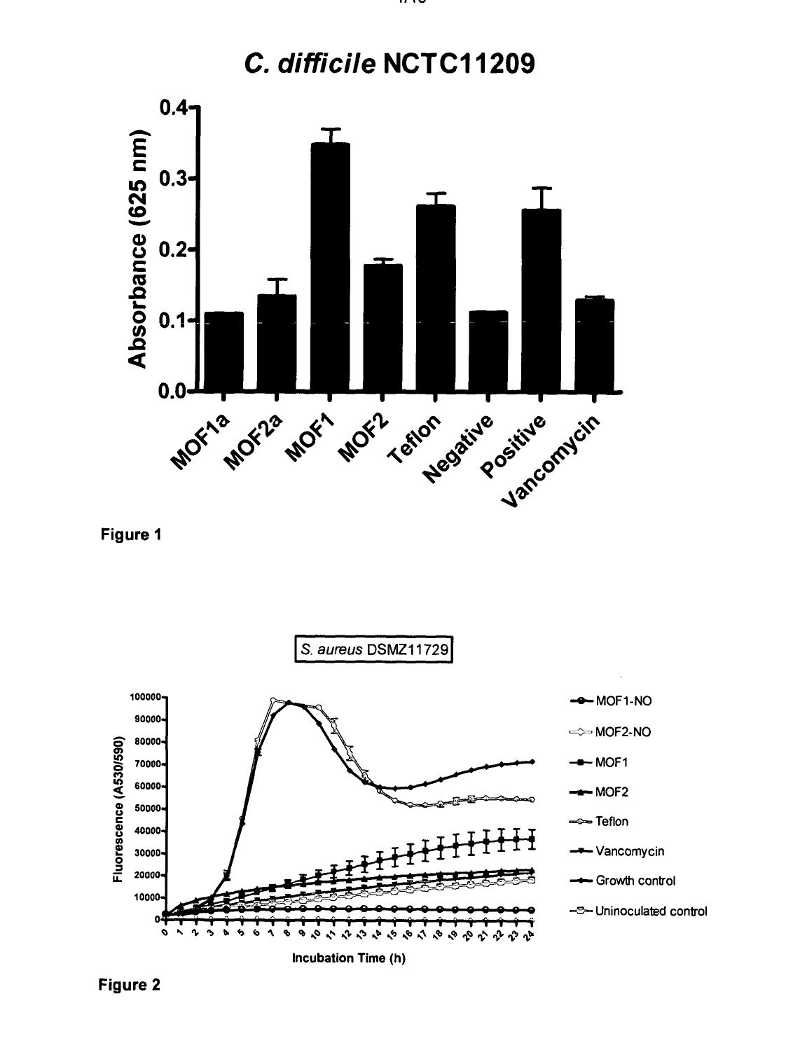

FIG. 1. Shows a graph of Growth inhibition of C. difficile NCTC11209 by Metal Organic Frameworks. The results in FIG. 1 demonstrate that both of the nitric oxide (NO)-containing MOFs NO—Zn—CPO-27 (MOF1a) and NO—Ni—CPO-27 (MOF2a) inhibit growth of C. difficile NCTC11209 after 24 h incubation at 37° C. under anaerobic conditions. Additionally, Ni—CPO-27 (MOF-2) inhibits growth of C. difficile NCTC11209 without NO impregnation, whereas Zn—CPO-27 (MOF1) does not inhibit growth of C. difficile NCTC11209. The growth was assessed by Gram staining and this confirmed the presence of a Gram positive rod. The Teflon controls did not inhibit growth of C. difficile NCTC11209.

FIG. 2—Shows a graph of Growth inhibition of S. aureus DSMZ11729 by Metal Organic Frameworks. The results in FIG. 2 demonstrate that both of the nitric oxide (NO)-containing MOFs, NO—Zn—CPO-27 (MOF1-NO) and NO—Ni—CPO-27 (MOF2-NO) inhibit growth of S. aureus DSMZ11729 after 24 h incubation at 37° C. under aerobic conditions. Additionally, Ni—CPO-27 MOF2 inhibits growth of S. aureus DSMZ11729 without NO impregnation. The Zn—CPO-27 (MOF1) also shows some antibacterial effect on S. aureus DSMZ11729. Teflon controls did not inhibit growth of S. aureus DSMZ11729.

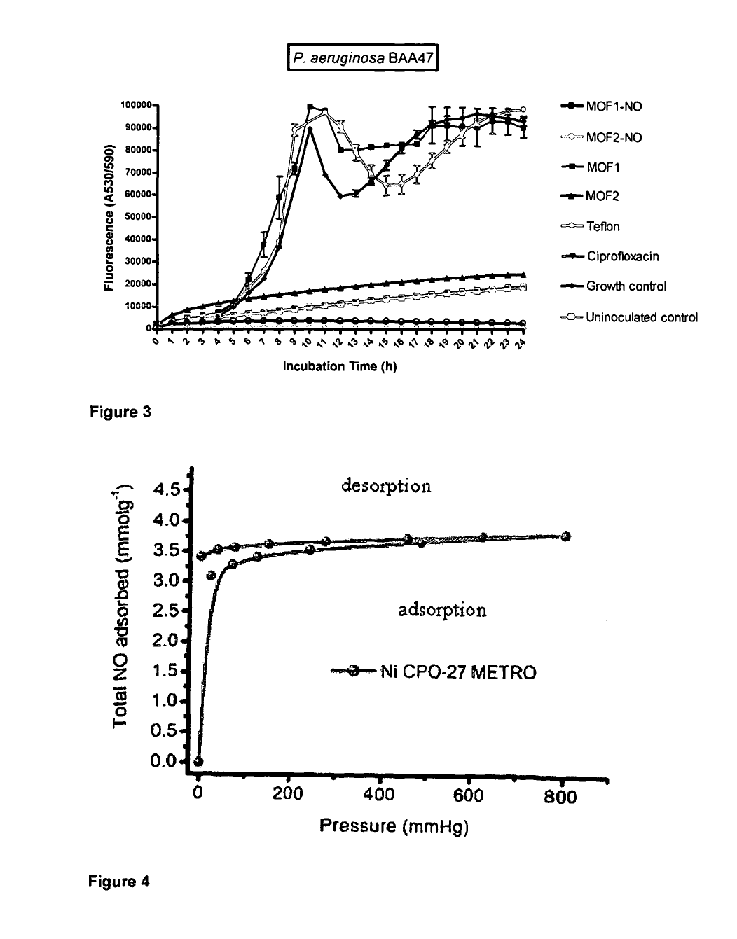

FIG. 3—Shows a graph of Growth inhibition of P. aeruginosa BAA-47 by Metal Organic Frameworks.

The results in FIG. 3 demonstrate that both of the nitric oxide (NO)-containing MOFs NO—Zn—CPO-27 (MOF1a) and NO—Ni—CPO-27 (MOF2a) inhibit growth of P. aeruginosa BAA-47 after 24 h incubation at 37° C. under aerobic conditions. Additionally, Ni—CPO-27 (MOF2) inhibits growth of P. aeruginosa BAA-47 without NO impregnation. The Teflon controls did not inhibit growth of P. aeruginosa BAA-47.

FIG. 4. NO adsorption/desorption isotherms on metronidazole-loaded Ni—CPO-27 (NI-CPO-27 METRO). This graph shows that even after loading of the Ni—CPO-27 MOF material with metronidazole there is still room for the adsorption of NO. The MOF takes up approximately half as much NO as the ‘bare’ Ni—CPO-27 MOF

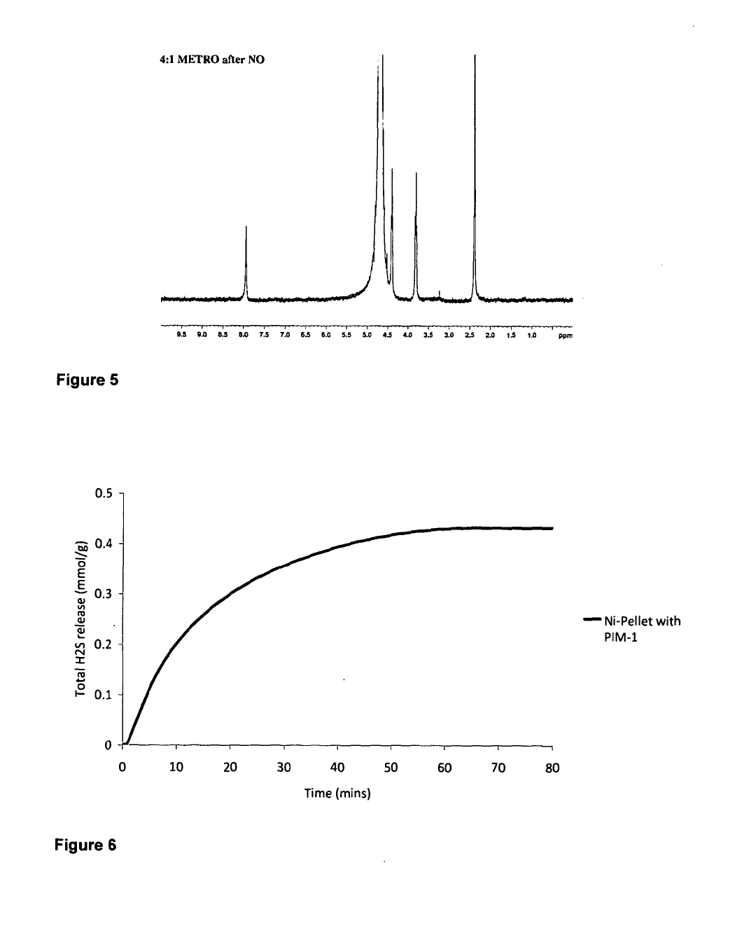

FIG. 5 shows—¹H NMR of D2O after being in contact with NO- and metranodazole-loaded Ni—CPO-27, after the material has desorbed all (−3.5 mmol g-1) nitric oxide. The ¹H NMR clearly shows the resonances associated with the metronidazole molecule

FIG. 6 shows The profile of hydrogen sulfide release over time from a pellet of Ni—CPO-27 over

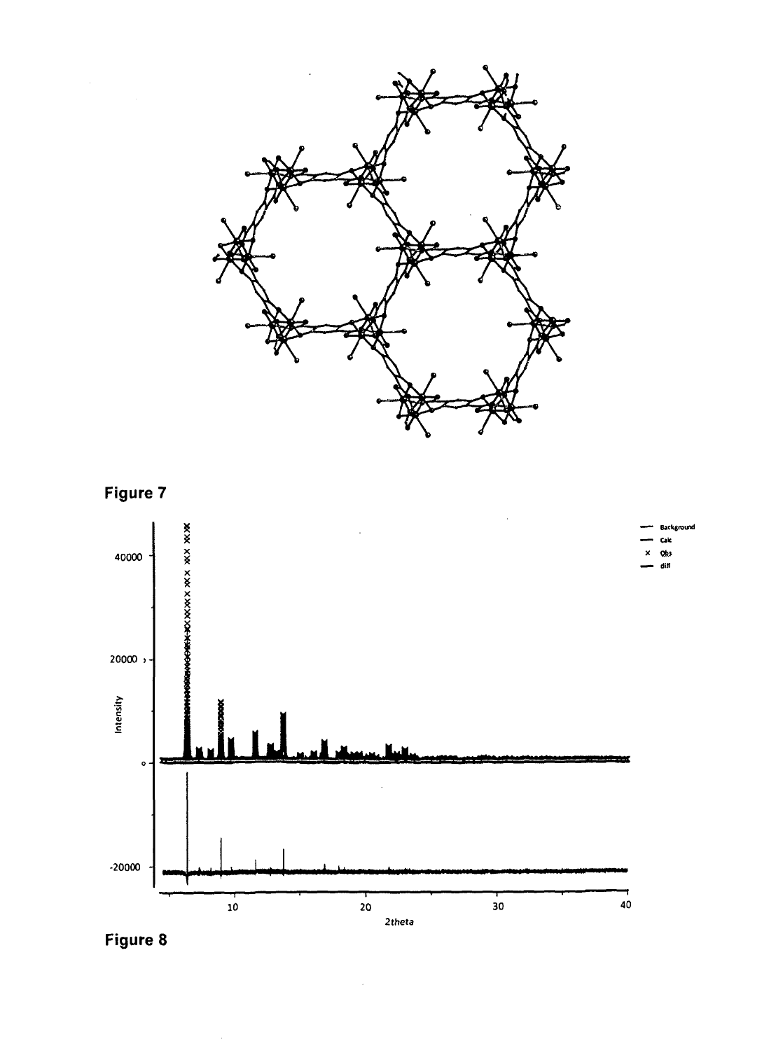

FIG. 7 shows The structure of Hydrogen sulfide loaded structure of Ni—CPO-27 from powder X-ray diffraction experiments showing the sulfur atom bonded to the metal in the structure.

FIG. 8 shows Rietveld refinement of the hydrogen sulfide loaded Ni—CPO-27 framework with the structure shown above. Rw=18.38%, Reduced χ²=15

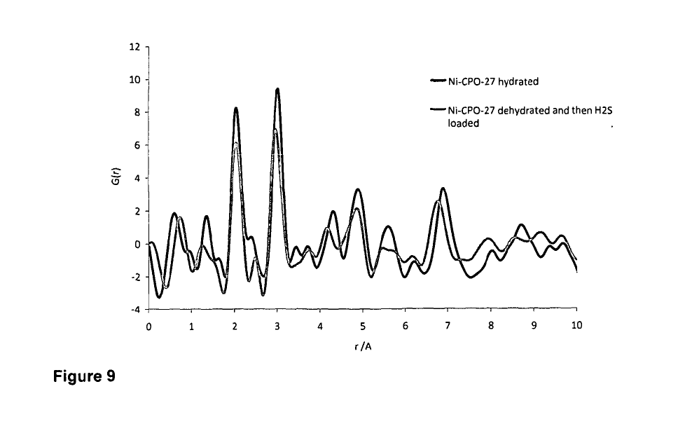

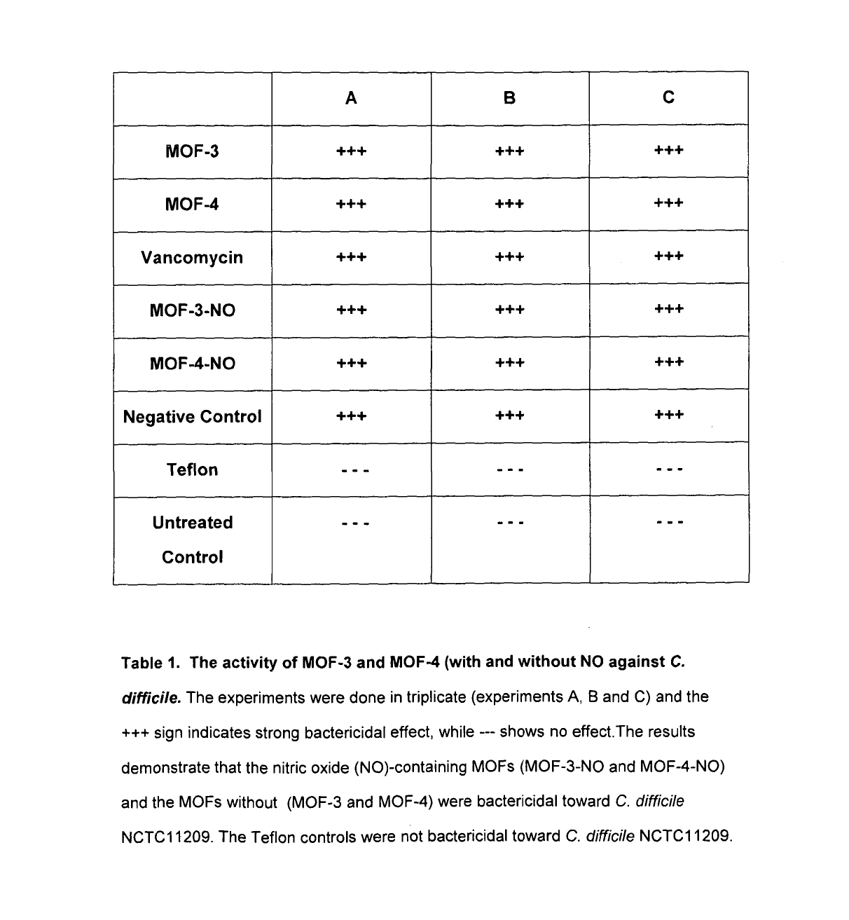

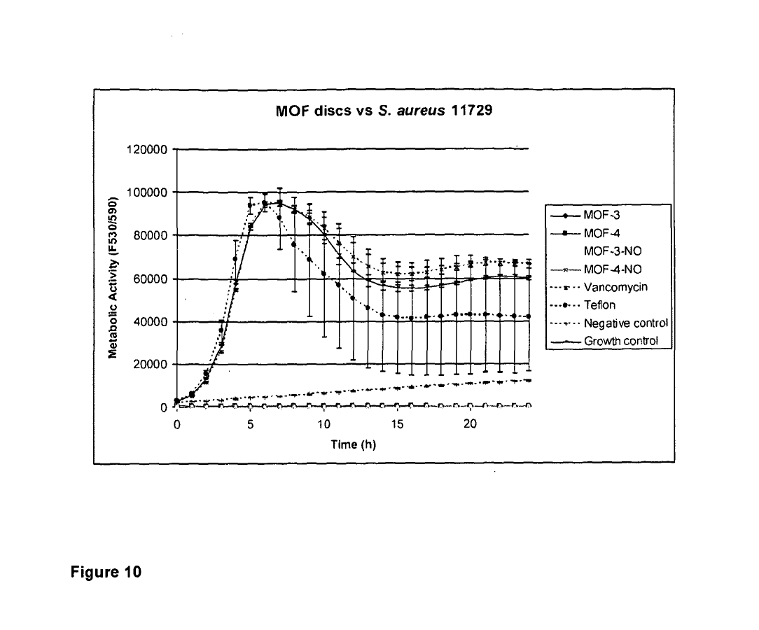

FIG. 9 shows Pair Distribution Function (PDF) Analysis for the hydrated and hydrogen sulfide loaded powder samples of Ni—CPO-27. The important peak is to strng peak at r=2.6 Å, indicating the Ni—S bond seen I nthe X-ray diffraction experiments.

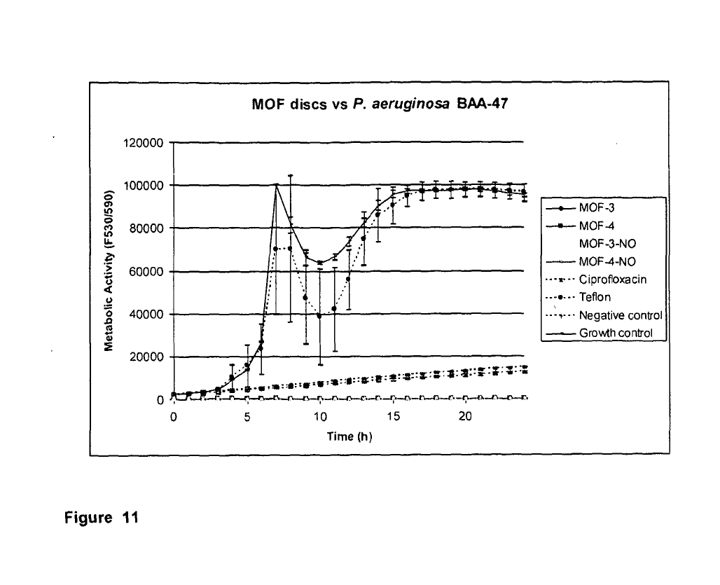

FIG. 10 shows a graph where the results demonstrate that the nitric oxide (NO)-containing MOFs (MOF-3-NO and MOF-4-NO) and the MOFs without (MOF-3 and MOF-4) were bactericidal toward S. aureus DSMZ11729. The Teflon controls were not bactericidal toward S. aureus DSMZ11729.

FIG. 11 shows a graph where The results demonstrate that both the nitric oxide (NO)-containing MOFs (MOF-3-NO and MOF-4-NO) and the MOFs without NO MOFs (MOF-3 and MOE-4) inhibit growth of P. aeruginosa BAA-47 after 24 h incubation at 37 oC under aerobic conditions. The Teflon controls did not inhibit growth of P. aeruginosa BAA-47.

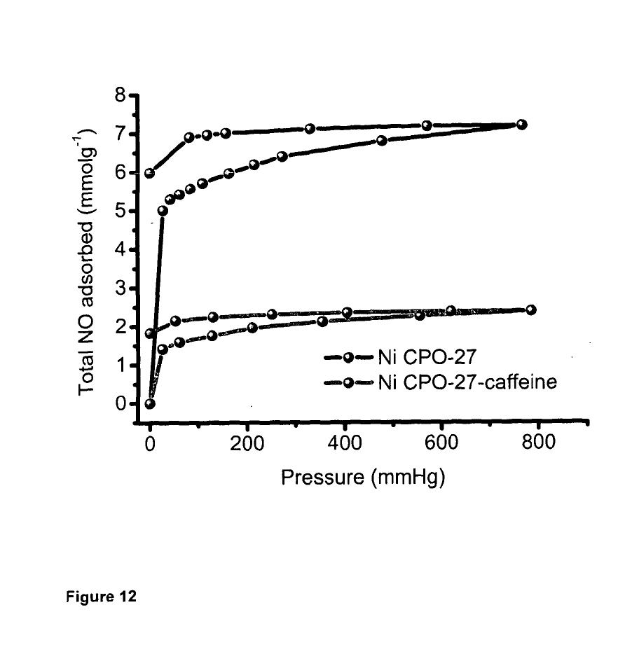

FIG. 12 shows a comparison between NO adsorption/desorption isotherms of non-drug-loaded MOF (Ni CPO-27 dehydrated at 150° C.) and caffeine-loaded Ni—CPO-27 (dehydrated at 80° C. to ensure no loss of drug). The caffeine-loaded material still adsorbs significant amounts of NO.

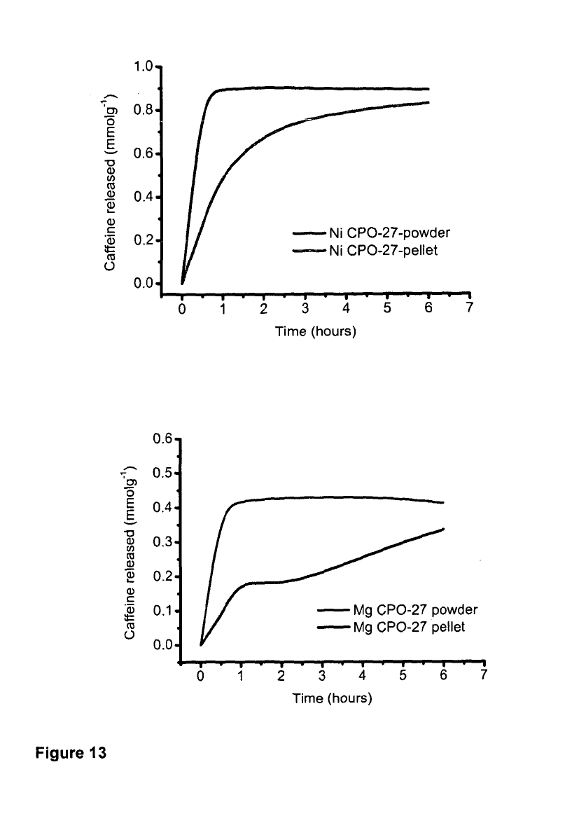

FIG. 13 shows the release profile into water (as measured by UV specroscopy) of caffeine from caffeine-loaded Ni—CPO-27 and caffeine-loaded Mg-CPO-27. The measurements were done from powdered and pelletised samples.

### EXAMPLES SECTION

The key for the figures (identification of MOFs) is as follows. The chemical formula given is of the dehydrated material. The as-made materials will contain solvent molecules (water or ethanol) in the channels of the structure.

MOF1-Ni—CPO-27 Chemical formula Ni₂(C₈H₂O₆)
MOF2-Zn—CPO-27 Chemical formula Zn₂(C₈H₂O₆)
MOF3-HKUST-1 Chemical formula Cu₂(C₉H₃O₆)
MOF4-STAM-1 Chemical formula Cu(C₁₀H₆O₆)

### MOF1-NO—NO-loaded Ni—CPO-27

MOF1a—NO-loaded Ni—CPO-27 (MOF1a is equivalent to MOFI—NO)

### MOF2-NO—NO-loaded Zn—CPO-27

MOF2a-NO—loaded Zn—CPO-27 (MOF2a is equivalent to MOF2-NO)

### MOF3-NO—NO-loaded HKUST-1

### MOF4-NO—NO-loaded STAM-1

### Example 1

### Antibacterial Activity of Ni—CPO-27 (MOF1)

### Novelty: First Demonstration of Anti-Bacterial of a MOF Itself

(i) Synthesis of Ni—CPO-27 [Adapted from P. D. C. Dietzel, B. Panella, M. Hirscher, R. Blom and H, Fjellvag, Chem. Comm., 2006, 959-961]

A solution of nickel acetate tetrahydrate (0.373 g, 1.5 mmol) in water (10 mL) and a solution of 2,5-dihydroxyterephthalic acid (0.149 g, 0.75 mmol) in tetrahydrofuran (10 mL) were combined in a Teflon-lined autoclave and reacted at 100° C. for three days. The product was collected by filtration and washed with water.

### (ii) Preparation of Discs for Anti-Microbial Testing

Teflon (polytetrafluoroethylene) and the required MOF were mixed homogeneously in a 20:80 wt % ratio, respectively. This mixture was then pressed into discs (0.020 g, 5 mm diameter) using 2 tons pressure for 30 seconds. Teflon controls (0.020 g) were prepared using the above method.

(iii) Sterilisation of Discs

The discs were placed in glass ampoules and heated at 150° C. for 5 hours under vacuum (1×10⁻⁴ torr). The discs were cooled over an atmosphere of argon (1 bar) and flame sealed.

### (iv) Antibacterial Testing

All solutions were prepared using 18 MΩ grade purified water. The 0.5 McFarland Standard was purchased ready-prepared (ProLab Diagnostics Inc; Cat No SD2300, Lot No 13418).

Two water-soluble antibiotics were used as positive controls for antibacterial activity: 16 μg/ml Vancomycin (Sigma-Aldrich Co; Cat No V1764, Batch No 016K11021) and 16 μg/ml Ciprofloxacin (Sigma-Aldrich Co; Cat No 17850, Batch No é

All growth media were sterilised by autoclaving for 15 min at 121° C. Cooked Meat medium (Oxoid; Cat No CM0081, Lot No 1107125) was prepared according to the manufacturer's instructions. Mueller Hinton broth (Oxoid; Cat No CM045B, Lot No 724245) was prepared according to the manufacturer's instructions. Mueller Hinton agar was prepared by the addition of 15 g/l agar (Sigma-Aldrich; Cat No A1296, Lot No 117K0129) to Mueller Hinton broth prior to autoclaving.

Brain Heart Infusion (BHI) broth (Oxoid; Cat No CMO225, Lot No 394599) was prepared according to the manufacturer's instructions, but with the following modifications to make it suitable for growth of anaerobic bacteria. In addition to 37 g/l BHI powder, 2 g/l yeast extract (Oxoid; Cat No LP0021, Lot No 988468), 2 g/l dextrose (Oxoid; Cat No LP0071, Lot No 929216) and 0.5 g/l cysteine (Sigma-Aldrich; Cat No 168149, Lot No S39490516) were added prior to autoclaving. When BHI agar was required, 20 g/l agar (Sigma-Aldrich; Cat No A1296, Lot No 117K0129) was added prior to autoclaving.

The following bacterial strains were tested to determine the antimicrobial activity of MOFs:

1. Clostridium difficile NCTC11209

2. Staphylococcus aureus DSMZ11729

3. Pseudomonas aeruginosa BAA-47

Antimicrobial susceptibility testing to determine the growth inhibition by the test items was carried out using modifications of the following Clinical and Laboratory Standards Institute (CLSI) Approved Standards:
1. Methods for Dilution Antimicrobial Susceptibility Tests for Bacteria that Grow Aerobically (M07-A8)
2. Methods for Antimicrobial Susceptibility Testing of Anaerobic Bacteria (M11-A7)

Antimicrobial susceptibility testing using the above CLSI Approved Standards requires test antimicrobial materials to be in an aqueous solution. As MOFs are solid disks it was not possible to follow these methods precisely.

The MOFs were not optically transparent and therefore did not permit kinetic analysis of microbial growth by changes in optical density. Therefore, the above CLSI protocols were adapted to monitor microbial metabolic activity using 10% (v/v) resazurin (a cell viability indicator) which detected growth by changes in fluorescence rather than optical density.

In the case of the anaerobic bacterium C. difficile it was not possible to analyse growth in a kinetic manner. Therefore, antimicrobial efficacy was determined via an end-point measurement after exposure for 24 h using optical density measurements (625 nm) of aliquots from the test items-containing wells.

The bactericidal effects of the test items were determined after determination of growth inhibition. An aliquot (10 μl) from each well was transferred to a new 96-well microplate containing the relevant growth medium without supplementation with antimicrobial agents or test items. The plates were incubated for 24 h at 37° C. (anaerobically in the case of C. difficile) and the optical density was determined at 625 nm. An increase in optical density greater than the negative control, following confirmation by Gram staining, indicated that the agent was bacteriostatic. Lack of growth indicated that the agent was bactericidal.

Optical density measurements and changes in fluorescence were determined using a BioTek Synergy HT Multi-Mode Microplate Reader.

### (v) Results

1. Clostridium difficile NCTC 11209

The results of the testing against Clostridium difficile NCTC11209 (FIG. 1) show that the Ni—CPO-27 MOF inhibits growth of C. difficile NCTC11209 after 24 h incubation at 37° C. under anaerobic conditions. The growth was assessed by Gram staining and this confirmed the presence of a Gram positive rod. The Teflon controls did not inhibit growth of C. difficile NCTC11209.

FIG. 1 shows the quantification of these results (average of results done in triplicate) and a comparison with several of the results from other examples.

2. Staphylococcus aureus DSMZ11729

Ni—CPO-27 MOF inhibits growth of S. aureus DSMZ11729. The results are shown in FIG. 2. The Teflon disks showed no activity against the bacteria

3. Pseudomonas aeruginosa BAA-47

Ni—CPO-27 MOF inhibits growth of Pseudomonas aeruginosa BAA-47. The results are shown in FIG. 3. The Teflon disks showed no activity against the bacteria

### Example 2

### Antibacterial Testing of NO-Loaded Ni—CPO-27 (MOF1-NO)

### Novelty: First Demonstration of Improved Antibacterial Activity Through Two Different Mechanisms

(i) Samples of Ni—CPO-27 MOF were synthesised as per example 1 sections (i) to (iii)

### (i) Nitric Oxide Loading of Teflon-MOF Discs

The discs (as prepared in example 1) were placed in glass ampoules and heated at (150° C. for Ni—CPO-27 and 260° C. for Zn—CPO-27) for 5 hours under vacuum (1×10⁻⁴ torr). The discs were cooled and then placed in an atmosphere of nitric oxide (2 bar) for 30 minutes. This was then evacuated, replaced with argon. Evacuation-argon procedure was repeated twice more. The final samples were placed over an atmosphere of argon and flame sealed.

### (ii) Antibacterial Testing was Completed as in Example 1.

(iii) Results

The NO-loaded Ni—CPO-27 showed bactericidal effects against all 3 strains of bacteria
1. Clostridium difficile NCTC11209
2. Staphylococcus aureus DSMZ11729
3. Pseudomonas aeruginosa BAA-47

The results of this work are shown in FIGS. 1, 2 and 3 respectively

### Example 3

### Synthesis of Metronidazole-Loaded Ni—CPO-27 (MOF1-Met)

### Novelty: First Demonstration of Loading an Antibacterial Molecule Inside an Antibacterial MOF (or Any MOF)

The Ni CPO-27 samples were degassed at 150° C. overnight to ensure full dehydration. These were then sealed in the vials for use later.

Calculated amounts of metronidazole were added into a glass jar, to this an amount of dry methanol was added and the jar was sealed while the metronidazole dissolved.

Once the metronidazole was dissolved an appropriate amount of the dehydrated Ni CPO-27 was added. The mixture was then left stirring for 2 days.

The mixture was filtered and washed with methanol before being air-dried.

Elemental analysis, TGA and ¹H NMR measurements were used to prove that metronidazole had indeed been adsorbed in the pores of Ni CPO-27. CHN elemental analysis, using the calculated and expected ratios of both the hydrated and activated samples of Ni CPO-27 as a comparison shows that metronidazole is adsorbed into the material. The results obtained on the metranidazole-loaded Ni—CPO-27 were as follows: C=31.98%, H=3.66% and N=3.46%. This result shows clearly that metronidazole has been adsorbed as metronidazole contains 3 nitrogen atoms per molecule, whereas Ni CPO-27 does not contain any nitrogen atoms. Calculating the amount of metronidazole present using these ratios gives a formula of Ni₂(C₈H₂O₆).0.3(C₆H₉N₃O₃). This results in an estimation of 0.165 g of metronidazole adsorbed for 1 g of activated MOF.

The metronidazole-containing Ni—CPO-27 was then exposed to water (D₂O) for 24 hours at room temperature. 1H NMR measurements on the liquid (after removal of the MOF solid by filtration) showed the presence of peaks associated with metronidazole in solution. This proves that the metranidazole is adsorbed into and released from the MOF intact and that the metranidazole-loaded MOF can be used as a delivery agent for the antibiotic molecule.

### Example 4

### Synthesis of NO- and Metronidazole-Loaded Ni—CPO-27 (MOFI-NO-Met)

Novelty: First Demonstration of a Trifunctional Antibacterial MOF which Will Kill Bacteria Through Three Different Mechanisms.

A sample of metronidazole-loaded Ni—CPO-27 as prepared in Example 3 was degassed at 80° C. under vacuum (the highest temperature possible before removal of the antibiotic) and then NO adsorption investigations were carried out. FIG. 4 shows the amount of NO adsorbed by the metronidazole-loaded Ni—CPO-27.

The total capacity of the metronidazole-loaded Ni—CPO-27 is reduced from the bare framework (˜7 mmole), due to the metronidazole now present in the pores. It is however noticeable that there are still coordinatively unsaturated metal sites available for the NO to bind to (also evidenced by the expected colour change when NO attaches to the open metal) as there is a distinct hysteresis present in the desorption arm of the graph. This total NO capacity is still extremely large and potentially significant for biological applications. To see if the NO adsorbed can still be released and delivered some samples of metronidazole-loaded Ni—CPO-27 were dehydrated at 80° C. under vacuum before being exposed to 2 atm of NO. Again the expected colour change was observed (dark yellow to dark green). Once loaded the samples were run on the Chemiluminescence NO analyser. The results showed that the same amount of NO as was adsorbed (˜3.5 mmol g-1) was released on contact with a moist gas.

Finally to show that metronidazole was still present in the pores of the MOF even after NO insertion and removal, the sample post NO analyser was placed in a vial with D₂O and left for 1 day. The remaining metronidazole should be triggered out of the pores when immersed in water (or deuterium oxide). A ¹H NMR was run and it was shown the D₂O contained metronidazole (see FIG. 7) as a sample metronidazole was dissolved in D₂O and run as a comparison,

The results show that an antibiotic molecule (metronidazole) and a bacteriacidal gas (nitric oxide) can be loaded simultaneously into a MOF material, which itself has antibacterial properties. This is therefore a trifcuntional antibacterial material.

### Example 5

### Synthesis of HA-Loaded Ni—CPO-27 MOF1-H2S

Novelty: The First Demonstration of H₂S Released from a MOF in Biological Quantities. First Crystallographic Location of H₂S Molecule Chemically Bound to a MOF

The metal-organic framework nickel 2,5-dihydroxyterephthalate hydrate (Ni—CPO-27) was synthesised as in example 1.

Pellets of the material was prepared by grinding a sample (˜0.02 g) of the material with PIM-1 polymer (˜10 wt %, Macromolecules 2010, 43, 5163-5176) before pressing into 5 mm² pellets to 2 tons using a uniaxial pellet press. The pellets were then heated slowly to 150° C. under vacuum for 24 hours to ensure complete activation of the materials. The samples were cooled to room temperature and exposed to ˜1 atm of hydrogen sulfide for 1 hour. The samples were evacuated and exposed to argon. The process of evacuation and argon exposure was repeated another 2 times and the pellets sealed in glass vials under argon,

The H₂S loaded Ni—CPO-27 MOF released approximately 0.4 mmol H₂S per g of MOF material (FIG. 6). The location of the adsorbed H₂S connected to the metals in the MOF (FIG. 7) was determined using powder X-ray diffraction of the H₂S loaded material (data collected at the Diamond synchrotron source, FIG. 8) and by pair distribution function analysis (FIG. 9, data collected at the APS in Chicago, USA).

### Example 6

### Antibacterial Activity of Zn—CPO-27 MOF (MOF2)

(i) Synthesis of Zn—CPO-27 [adapted D. J. Tranchemontagne J. R. Hunt and O. M. Yaghi, Tetrahedron, 2008, 64, 8553-8557]

A solution of 2,5-dihydroxyterephthalic acid (0.239 g, 1.20 mmol) in dimethylformamide (20 mL) was slowly added to a solution of zinc acetate dihydrate (0.686 g, 3.12 mmol) in dimethylformamide (20 mL) over a period of ten minutes, and the mixture stirred for a further 18 hours at room temperature. The product was centrifuged and the mother liquor was decanted. The product was washed with dimethylformamide and methanol. It was then immersed in methanol overnight. This methanol wash-immersion procedure was repeated twice more. The methanol was decanted and the product evacuated at room temperature for 7 hours. The temperature was then raised to 110° C. for 10 hours and then to 260° C. for a further 12 hours under vacuum. It was then cooled to room temperature to yield the final product.

(ii) Disks were prepared and used in antibacterial testing as described in Example 1.

### Results

The Zn—CPO-27 showed mild bacteriostatic effects against Staphylococcus aureus DSMZ11729 but was ineffective against the other two organisms. The results are summarized in FIGS. 1, 2 and 3.

### Example 7

### Antibacterial Activity of NO-Loaded Zn—CPO-27 (MOF2-NO)

NO-loading of Zn—CPO-27 was carried out as described in example 2 and tested against the three strains of bacteria

### Results

NO-loaded Zn—CPO-27 was shown to be active against all three bacteria strains. The results are summarised in FIGS. 1, 2 and 3.

### Example 8

### Antibacterial Activity of HKUST-1 MOF (MOF3 and MOF4-NO)

Synthesis of HKUST-1 was carried out as per the literature (adapted from Xiao, B; Wheatley, PS; Zhao, XB, et al. JOURNAL OF THE AMERICAN CHEMICAL SOCIETY Volume: 129 Issue: 5 Pages: 1203-1209 Published: Feb. 7, 2007). Antibacterial testing, including preparation of samples, was carried out as in example 1.

Both HKUST-1 and HKUST-1 loaded with NO were active against

1. Clostridium difficile NCTC11209
2. Staphylococcus aureus DSMZ11729
3. Pseudomonas aeruginosa BAA-47

Please see Table 1 and FIGS. 7 and 8 for the detailed results.

### Example 9

### Synthesis and Structure of STAM-1 MOF (MOF4 and MOF4-NO)

In a further aspect there is provided a novel antimicrobial MOF(STAM-1) with the following formula Cu(C₁₀H₆O₆)

### (i) Synthesis of STAM-1 Cu(C₁₀H₆O₆)(H₂O),1:66 H₂O.

4.1 mmol of Cu(NO₃)₂.3(H₂O) (0.991 g) and 4.1 mmol of 1,3,5-benzenetricarboxylic acid (H₃BTC) (0.862 g) was mixed with 20 ml of MeOH/H₂O (50:50) in a Teflon-lined steel autoclave. The mixture was stirred for 15 minutes at ambient temperature prior to heating at 383 K for 7 days. The autoclave was cooled to room temperature and large blue crystals were isolated by Buchner filtration and dried in air. The best yield for the process approaches 100%, and yields in excess of 95% can be obtained easily and repeatably. Longer heating times can lead to a very small amount of HKUST-1 (<1% from XRD) as an impurity. The reaction can successfully be scaled up to produce at least 2.5 g of STAM-1 from any one reaction.

### (ii) Crystal Structure of STAM-1

### Methods

Single crystals of STAM-1 were analysed using a Rigaku Mercury CCD equipped with graphite monochromated Mo-Kα radiation. Intensity data were collected by the narrow frame method at 293 K and corrected for Lorentz and polarisation effects as well as absorption by Multi-Scan techniques. All structures were solved by direct methods and refined by full-matrix least-squares cycles in SHELX97. All non-hydrogen atoms were refined with anisotropic thermal parameters. Hydrogen atoms attached to C and N were located at geometrically calculated positions and refined with isotropic thermal parameters, while those attached to O were found, where possible, by Fourier techniques and refined isotropically.

### Crystal Data for Structure Determination of STAM-1

| Identification code | stam1 |
|---|---|
| Empirical formula | Cu(C₁₀H₆O₆) (H₂O) 1.66 H₂O |
| Formula weight | 333.6 |
| Temperature | 293(2)K* |
| Wavelength | 0.71073 Å |
| Crystal system, space group | Trigonal, P-3m1 |
| Unit cell dimensions | a = 18.6500(17) Å |
| | b = 18.6500(17) Å |
| | c = 6.8329(9) Å |
| Volume | 2058.2(4) Å³ |
| Z | 6 |
| Calculated density | 1.615 g cm⁻¹ |
| Absorption coefficient | 1.628 mm⁻¹ |
| F(000) | 1018 |
| Crystal size | 0.09 × 0.08 × 0.05 mm |
| Theta range for data collection | 3.24 to 27.38 deg. |
| Limiting indices | −24<=h<=19, −22<=k<=24, −8<=I<=6 |
| Reflections collected/unique | 14358/1647[R(int) = 0.0689] |
| Completeness to theta = 27.38 | 96.7% |
| R1 (I >2□(I), wR2 (All data) | 0.056, 0.1415 |

*Structure has been confirmed at 100K using synchrotron radiation

The structure of STAM-1 contains the same Cu ‘paddle wheel’ unit that is seen in HKUST-1. The paddle wheels are connected into approximately triangular ‘cups’ (FIG. 6a) reminiscent of calixarenes, with the paddle wheels at the narrow end of the cup, and the wide end delimited by the ester groups. The calixarene-type cups are arranged in a hexagonal pattern with alternating up-down-up orientations to form the layered structures shown in FIG. 6b. This arrangement leads to hydrophilic space lined by metal ions inside the cups and hydrophobic cavities lined only by organic groups between the cups. The hydrophobic/hydrophilic nature of the material is clear from the single crystal X-ray diffraction experiments—the hydrophilic channel contains ordered water molecules while no ordered scattering can be found in the hydrophobic channel (FIG. 6c).

The layers stack directly on top of each other to yield the final structure. The hydrophilic channels are therefore formed by stacked cups, leading to channels that undulate parallel to the crystallographic c-axis with a largest diameter, calculated from molecular modelling studies, of around 5.65 Å and windows into the pores of ˜4 Å diameter. The hydrophobic channels are best described as pseudo-cubic cages stacked on top of one another, with triangular entrance windows formed by the ester groups. The windows are approximately the same size (˜4 Å) as those in the hydrophilic channel.

Thermogravimetric analysis indicates that the guest molecules are lost from STAM-1 up to about 423 K and powder XRD confirms that the material after desolvation remains crystalline. High resolution X-ray diffraction reveals small but significant changes in the unit cell parameters. During the dehydration the shape of the unit changes slightly and the symmetry of the material is lowered from trigonal to triclinic (See supplementary material). Consistent with the XRD, changes also occur in the solid state ¹³C NMR of STAM-1 with the methyl resonance slightly broadening and larger changes happening to the aromatic resonances, which is consistent with the aromatic carbons being closer to the hydrophilic pore and the site of water in the hydrated STAM-1 structure.

### Example 10

### Anti-Bacterial Activity of STAM-1 (MOF4 and MOF4-NO)

Antibacterial testing was carried out as in example 1.

Both STAM-1 and STAM1 loaded with NO were active against

1. Clostridium difficile NCTC11209
2. Staphylococcus aureus DSMZ11729
3. Pseudomonas aeruginosa BAA-47

Please see Table 1 and FIGS. 7 and 8 for the detailed results.

### Example 11

### Synthesis and Characterisation of M-CPO-27 (M=Ni or Mg) with NO and Caffeine

This example shows the synthesis of a material that is itself antibacterial (Ni—CPO-27) or non-antibacterial (Mg-CPO-27) in combination with both an antibacterial guest (NO) and another guest molecule that is not normally regarded as antibacterial. The caffeine was loaded into the metal organic frameworks in the same manner as the metronidazole was loaded into the MOFs in the examples above, except the solvent used was dichloromethane instead of methanol. Confirmation of caffeine amounts within MOFs was done using solution IR and elemental analysis (see FIG. 12). ¹H NMR and UV spectroscopies were used to show that caffeine could be recovered from the solid after it had been contacted by water (see FIG. 13). The NO adsorption and delivery properties of the caffeine-loaded MOFs were measured using the techniques described in the previous examples.
¹ Eddaoudi, M., et al. Science 2002, 295, 469.
² G. Ferey, G. Chem. Soc. Rev 2008 37, 191.
³ B. Xiao et al, Nature Chem. 1, 289, 2009
(a) O. M. Yaghi et al. Nature, 423, 705, 2003 (b) H. Li et al Nature 402, 276, 1999. (c) Yaghi WO200288148-A
⁵ A. K. Cheetham et al, Science, 318, 58, 2007.
⁶ Horcajada et at WO2009077670 (A1)
⁷ Lin & Reiter WO2007124131
⁸ Morris & Wheately WO2008020218
⁹ Kolodkin-Gal, et al. Science 328, 627 (2010)
¹⁰ C. Walsh Antibiotics: Actions, Origins, Resistance, ASM Press; 1 edition (March 2003)

1. A method of preventing or treating microbial infection or contamination, the method comprising contacting a metal organic framework (MOF) material comprising two or more releasable anti-microbial agents which have been incorporated into the MOF, with a microbe, to thereby prevent or treat a microbial infection or contamination.

2. (canceled)

3. (canceled)

4. The method according to claim 1 wherein at least one anti-microbial agent is a solid or a liquid and at least one anti-microbial guest agent is gaseous.

5. The method according to claim 1 wherein the MOF comprises ions selected from the group consisting of Ag+, Zn+, Cu+, Cu²+ Ni²+ within the framework.

6. The method according to claim 1 wherein an organic linker within the MOF has anti-microbial activity.

7. The method according to claim 6 wherein the anti-microbial linker is synthesized by taking a metal source and combining the metal source with an organic linker having anti-microbial activity and suitable functionality.

8. The method according to claim 1 wherein the antimicrobial agents that are incorporated in the metal organic framework are selected from the group consisting of small molecules organic antimicrobial agents and molecules that bacterial biofilms to disassemble.

9. The method according to claim 1 comprising incorporating the MOF into a material selected from the group consisting of:
a. a polymers or a plastic
b. a cream or lotion
c. a textile or clothing material, and
d. a paint or a coating.

10. The method according to claim 1 wherein the metal organic framework comprising the two or more releasable anti-microbial agents is in the form of a powder or a monolith.

11. The method according to claim 1, wherein the metal organic framework is comprised within a coating.

12.-18. (canceled)

19. The method according to claim 1 wherein the MOF is STAM-1 (Cu(C₁₀H₆O₆)(H₂O)).

20. The metal organic framework STAM-1 (Cu(C₁₀H₆O₆)(H₂O)).

21-22. (canceled)

23. A metal organic framework (MOF) comprising two or more releasable anti-microbial agents stored within the metal organic framework.

24. The MOF according to claim 23, wherein at least one anti-microbial agent is a solid or a liquid liquid and at least one anti-microbial agent is gaseous.

25. The MOF according to claim 23, comprising an ion selected from the group consisting of Ag+, Zn+, Cu+, Cu²+ and Ni²+ ions within the metal framework.

26. The MOF according to claim 23, wherein the two or more antimicrobial agents stored in the metal organic framework are selected from the group consisting of small molecules, organic antimicrobial agents, and molecules that cause the disassembly of bacterial biofilms.

27. The MOF according to claim 23, comprised within a material selected from the group consisting of:
a. a polymer or plastic,
b. a cream or lotion,
c. a textile or clothing material, and
d. a paint or a coating.

28. The MOF according to claim 27, comprised in a coating on a medical device.

29. The MOF according to claim 23, wherein the framework is STAM-1 (Cu(C₁₀H₆O₆) (H₂O)).

30. A medical article comprising a metal organic framework (MOF), the MOF comprising two or more releasable anti-microbial agents stored within the metal organic framework.

31. A pharmaceutical, neutraceutical or cosmetic preparation comprising a metal organic framework comprising two or more releasable anti-microbial agents together with a pharmaceutical/neutraceutical/cosmetic carrier.

32. A method of releasing said two or more anti-microbial agents from a MOF according to claim 23, comprising the steps of
(i) providing said metal organic framework material comprising two or more anti-microbial agents;
(ii) contacting said metal organic framework material with a medium into which said two or more anti-microbial agents are to be released.

33. A MOF according to claim 23, comprising two or more releasable anti-microbial agents stored within the pores of the organic framework.

34. A MOF according to claim 23, comprising two or more two or more releasable anti-microbial agents adsorbed and stored within the metal organic framework.

35. The method of claim 8, wherein the small molecule is selected from the group consisting of carbon monoxide, hydrogen sulfide, and nitrogen monoxide; the organic antimicrobial agent is selected from the group consisting of penicillins, cephalosporins, aminoglycosides, glycopeptides, and macrolides; and the molecules that cause bacterial biofilms to disassemble are selected from D-amino acids and mixtures thereof.

36. The MOF of claim 26, wherein the small molecule is selected from the group consisting of carbon monoxide, hydrogen sulfide, and nitrogen monoxide; the organic antimicrobial agent is selected from the group consisting of penicillins, cephalosporins, aminoglycosides, glycopeptides, and macrolides; and the molecules that cause bacterial biofilms to disassemble are selected from D-amino acids and mixtures thereof.
